(19) United States
(12) Patent Application Publication
(10) Pub. No.: US 2009/0132963 A1
(43) Pub. Date: May 21, 2009

(54) METHOD AND APPARATUS FOR PACS SOFTWARE TOOL CUSTOMIZATION AND INTERACTION

(75) Inventors: Mark Morita, Arlington Heights, IL (US); Prakash Mahesh, Hoffman Estates, IL (US); Murali Kariathungal, Hoffman Estates, IL (US); Christopher Janicki, Barrington, IL (US); Fahd Arshad, East Elmhurst, NY (US); Jason Cornwell, Mountain View, CA (US); Shaelyn Clements, Santa Monica, CA (US); David Knight, San Francisco, CA (US); Madhu Prabaker, San Francisco, CA (US); Nina Shih, San Marino, CA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/943,979

(22) Filed: Nov. 21, 2007

(51) Int. Cl. G06F 3/048

(52) U.S. Cl. 715/834

(57) ABSTRACT

Certain embodiments of the present invention provide methods and systems for circular tool menu configuration and use with a clinical application. Certain embodiments provide a user interface providing software tools and customization for a picture archiving and communication system. The user interface includes a pie-shaped menu including a plurality of tool segments arranged as pieces of the pie-shaped menu. The user interface also includes a pointer movable by a user to select one of the plurality of tool segments in the pie-shaped menu. The user interface further includes an image review area displayed underneath the pie-shaped menu. In certain embodiments, the user interface further includes a tool bar including one or more tools and functions associated with a tool segment in the pie-shaped menu, for example.

### BACKGROUND OF THE INVENTION

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Currently, PACS systems display a full array of available tools redundantly in a PACS imaging window. As illustrated, for example, in FIG. 1, tool bars and functionality buttons clutter the screen. In the radiology industry, for example, redundant tools for radiology reading and other functions are positioned all over a workstation's imaging window, creating unnecessary clutter. As shown in FIG. 1, for example, a right click tool menu requires a radiologist to extensively navigate to select an appropriate imaging tool. Positioning of these tools in the viewing window forces the radiologist to search for a particular tool which, due at least in part to the complexity of the imaging screens, can cause inefficiencies in the reading workflow.

Current tools also force radiologists to select tools from locations on the imaging screens that require unnatural hand/mouse movements. Studies suggest that tool selection can account for up to 10% of the time taken for the diagnostic interpretation process.

### BRIEF SUMMARY OF THE INVENTION

Certain embodiments of the present invention provide methods and systems for circular tool menu configuration and use with a clinical application.

Certain embodiments provide a user interface providing software tools and customization for a picture archiving and communication system. The user interface includes a pie-shaped menu including a plurality of tool segments arranged as pieces of the pie-shaped menu. The user interface also includes a pointer movable by a user to select one of the plurality of tool segments in the pie-shaped menu. The user interface further includes an image review area displayed underneath the pie-shaped menu.

In certain embodiments, the user interface further includes a tool bar including one or more tools and functions associated with a tool segment in the pie-shaped menu, for example.

Certain embodiments provide a picture archiving and communication system. The picture archiving and communication system includes a circular menu including a plurality of wedge-shaped tool segments arranged within the circular menu. The system also includes a pointer movable by a user to select one of the plurality of tool segments in the pie-shaped menu. The system further includes an image review area displayed underneath the circular menu. Additionally, the system includes a memory storing configuration information for the circular menu.

In certain embodiments, the system includes a tool bar including one or more tools and functions associated with a tool segment in the circular menu.

Certain embodiments provide a computer-readable storage medium including a set of instructions for execution on a computer. The set of instructions includes a user interface routine providing a pie menu of tools, each tool comprising a wedge in the pie menu selectable by a user to apply a tool to one or more images being reviewed. The set of instructions also includes a configuration routine adapted to allow a user to configure tools in the pie menu by dragging and dropping tools onto the wedges in the pie menu. The configuration routine allows a user to save a configuration according to at least one of a user and a modality. Configuration routine is adapted to allow a user to configure a tool bar of complementary tools and functions related to one or more wedges in the pie menu, the tool bar adapted for display via the user interface routine upon selection of one or more corresponding wedges in the pie menu.

Certain embodiments provide a method for tool menu configuration for image review. The method includes providing available tools for a modality for configuration in a circular tool menu. The method also includes assigning available tools to segments in the circular tool menu based on user input. The method further includes saving configuration information for a user to allow the circular tool menu to be accessed by the user for the modality.

### BRIEF DESCRIPTION OF SEVERAL VIEWS OF THE DRAWINGS

FIG. 1 depicts a series of images including a plurality of significant images as well as a plurality of non-significant images in accordance with an embodiment of the present invention.

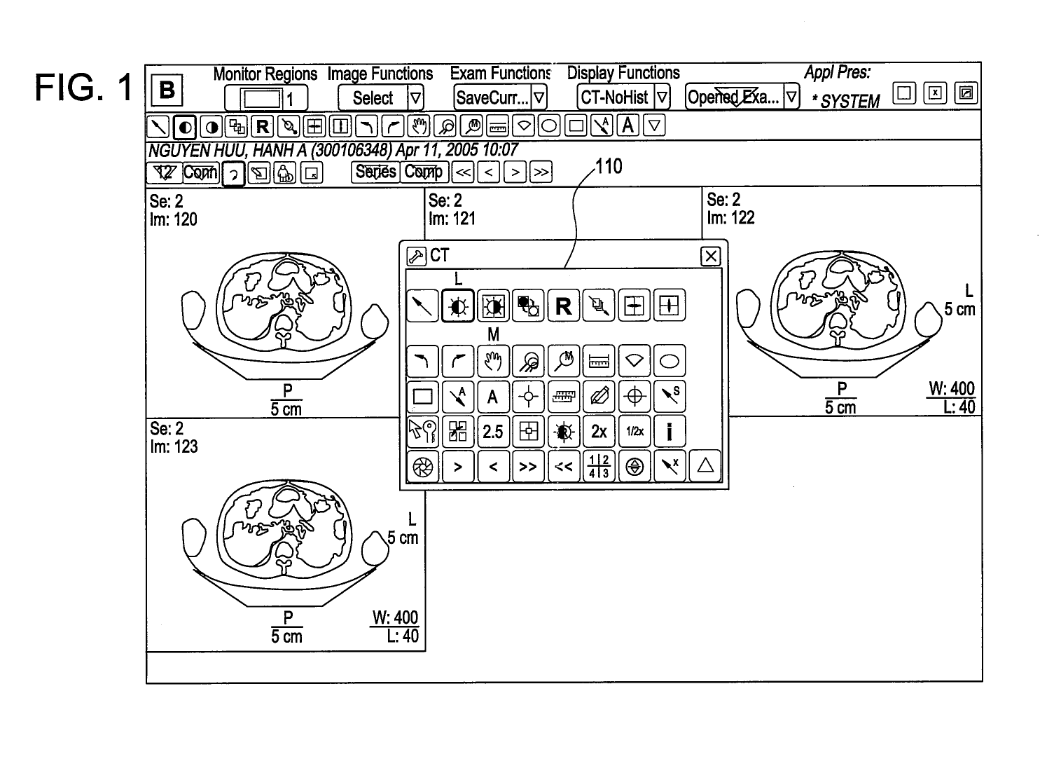

FIG. 2 illustrates an image viewing user interface according to an embodiment of the present invention.

FIG. 3 depicts an interface providing user-configurability of a pie menu in accordance with an embodiment of the present invention.

FIG. 4 illustrates a tool ribbon with an inverted ribbon functionality that updates to correspond with a currently selected pie wedge in accordance with an embodiment of the present invention.

FIG. 5 depicts an exemplary tool bar including inverted ribbon functionality in accordance with an embodiment of the present invention.

FIG. 6 shows another example of a tool bar having inverted ribbon functionality in accordance with an embodiment of the present invention.

FIG. 7 shows a flow diagram for a method for pie menu configuration and in accordance with an embodiment of the present invention.

FIG. 8 illustrates a system for clinical data storage and retrieval in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide a software based tool and associated systems and methods that allow users of a PACS system or related healthcare software application to easily select frequently-used tools with minimal searching on a user interface. Certain embodiments help to reduce redundant clutter on an image viewing screen, as welling as helping to reduce repetitive hand movements and helping to reduce a diagnostic interpretation process.

Certain embodiments provide a circular, pie-shaped menu that, upon activation, presents certain software tools to a user. For example, upon a right-click of a button, ball, wheel, switch and/or other action of a mousing device, the pie-shaped tool presents seven context sensitive software tools that include pan, zoom, window/level, cine, etc.

In certain embodiments, users are able to either activate a selected tool in a variety of ways. For example, a user may immediately click on his or her choice of tool to activate the tool from the menu. As another example, a user may mouse-down, drag and release the mouse button in an area of a selected tool to activate the tool from the menu. As another example, a user may use the mouse to click on the pie wedge at the six o'clock position to bring up a full set of tools from which to choose.

Certain embodiments allow PACS users to customize their preferred tools for each modality type (i.e., CT, MR, US, etc.) and also have an ability to quickly access the full set of tools available. To configure the pie menu for modality-specific tools, a user can open a particular modality type. Then, by clicking on or otherwise selecting the full array of tools, the user can drag and drop the preferred tools onto pie wedges. The user may select pie wedge locations for different tools according to a number of criteria including ease of use, frequency of use, etc.

In certain embodiments, in addition to the pie-shaped menu, complementary tools and functions associated with a selected tool may automatically populate on a tool bar, which could be positioned on the screen at the user's discretion. For example, when a selection arrow tool is enabled, an associated tool bar populates with related buttons and/or functions including select all, hide, show all, mark as significant, scout, reject, etc. Users can quickly select his or her tool from the pie menu and then quickly click to affect or leverage a related function.

Thus, certain embodiments provide a context sensitive pie menu including tools appropriate and/or customized for the particular context in which a PACS application is operating. Certain embodiments provide an associated tool ribbon or bar for the pie menu wedge items. Certain embodiments allow a user to customize the pie menu and tool ribbon or bar according to his or her applications and/or other preferences. Certain embodiments allow a user to access additional tools and/or access complimentary tools via the ribbon or bar.

The pie menu allows quick and easy access to, for example, the most frequently used tools. In other embodiments, the pie menu allows quick and easy access to the most recently used tools. The pie menu tool also affords an ability to drag and release an item in a gestural way that would allow for users to easily gesture to locations rather than having to look and choose particular tools on the screen. Thus, distractions, diversion of attention, and unnecessary computer interaction may be reduced.

An ability to drag and drop tools into the pie menu helps facilitate customization by a user. Context specific tools for each modality type help enable users to customize their menus for each specific modality rather than having to reconfigure the menu each time a modality is brought up.

Thus, a user interface including a pie menu and associated tool bar or ribbon may help eliminate redundant clutter on a viewing screen, allowing radiologists and clinicians to better focus on image information being displayed.

The new toolset helps improve or optimize the process of tool selection, which ultimately helps improve the diagnostic interpretation process.

In certain embodiments, in addition to allowing a user to customize a modality and context-sensitive tool menu using drag and drop functionality, the interface allows tool parameters and associated functions related to a specific tool to be accessed and customized by a user as well.

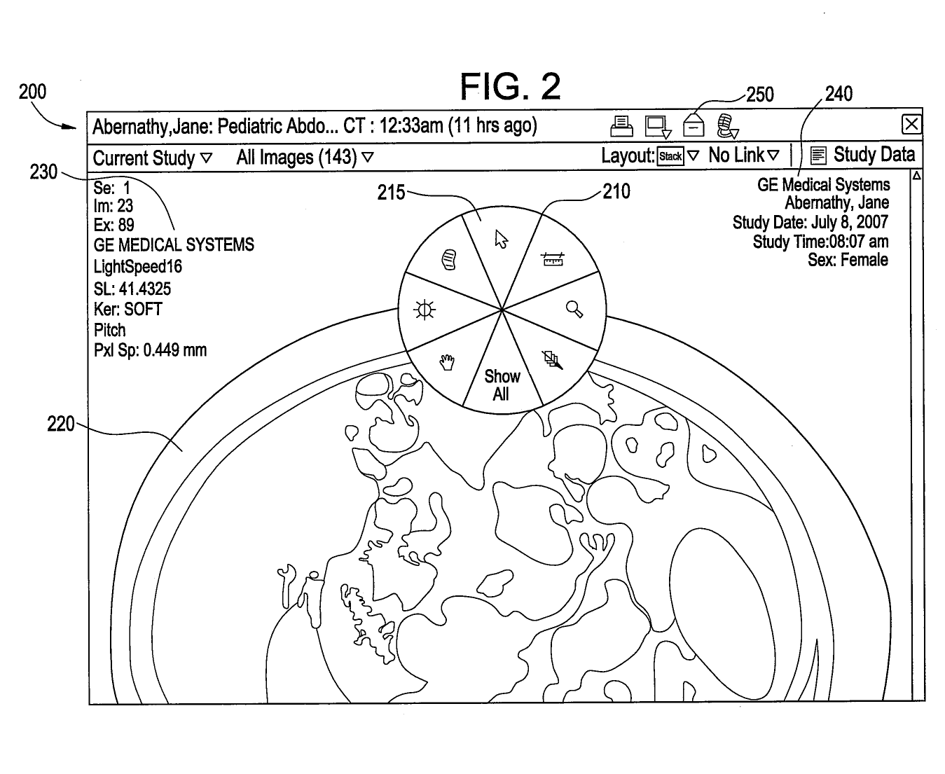

FIG. 2 illustrates an image viewing user interface 200 according to an embodiment of the present invention. The interface 200 includes, among other things, a pie menu tool 210, an image 220, image information 230, study information 240, and a tool ribbon 250. As depicted in FIG. 2, seven of the eight pie menu wedges 215 can be customized by a user to represent and trigger frequently accessed tools from a particular context or modality. In the example of FIG. 2, the eighth pie menu wedge 215 at the six o'clock position allows the user to bring up a full array of available tools in an organized fashion. In other embodiments not shown, the “show all” pie wedge may be positioned in another location on the menu tool 210. From the full tool windows, users have an ability to select their preferred tools and also drag and drop their favorite modality specific tools into the pie wedges 215 using a pointer, such as a mousing device and/or other instrument controlling an on-screen cursor, to setup their default favorites for a particular modality.

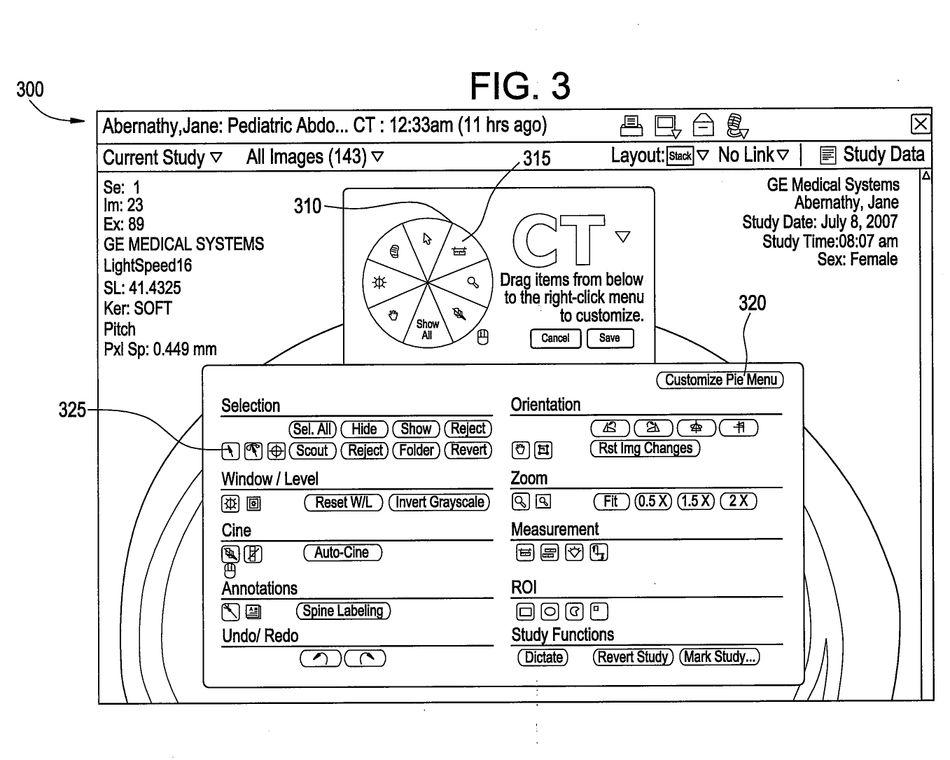

As shown in FIG. 3, an interface 300 is demonstrated that allows users an ability to select specific tools that are not found in a default pie menu 310. Clicking on and/or otherwise selecting any one of the tools 325 from a customization menu 320 selects the tool 325 for insertion into the pie menu 310. From this interface 300, users may also customize their default pie menu 310 for each modality. In the example of FIG. 3, computed tomography (CT) modality specific tools can be dragged and dropped to the user specific pie wedges 315 of choice. In certain embodiments, associated functions and/or tools, as well as tool parameters, may be selected and/or customized in conjunction with the tool(s) placed in the pie wedges 315.

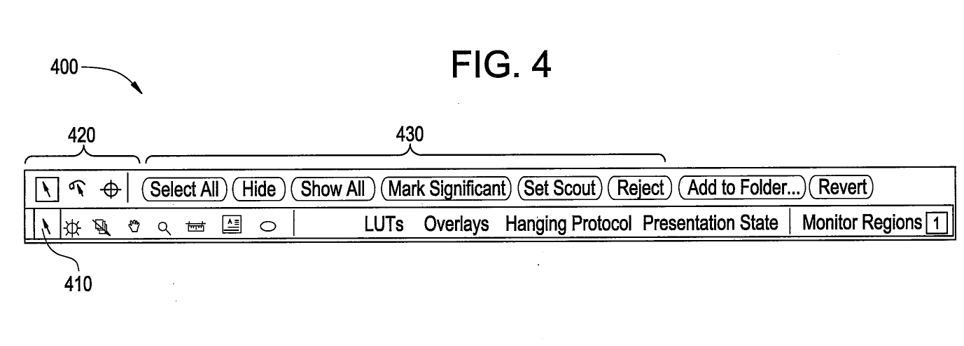

FIG. 4 illustrates a tool ribbon 400 with an inverted ribbon functionality that updates to correspond with a currently selected pie wedge in accordance with an embodiment of the present invention. As shown in FIG. 4, a selection arrow 410 is the chosen tool, so related selection tools 420 are displayed as well as associated functions 430 that include select all, hide, show all, mark significant, set scout, reject, etc. Displaying related functions helps enable users to quickly locate related functions. In certain embodiments, because the bar 400 updates dynamically based on a particular selected tool, related tools and functions do not need to be displayed pervasively within a user interface. In certain embodiments, related tools and functions on the bar 400 may be customized and/or otherwise configured by a user based on the selected tool.

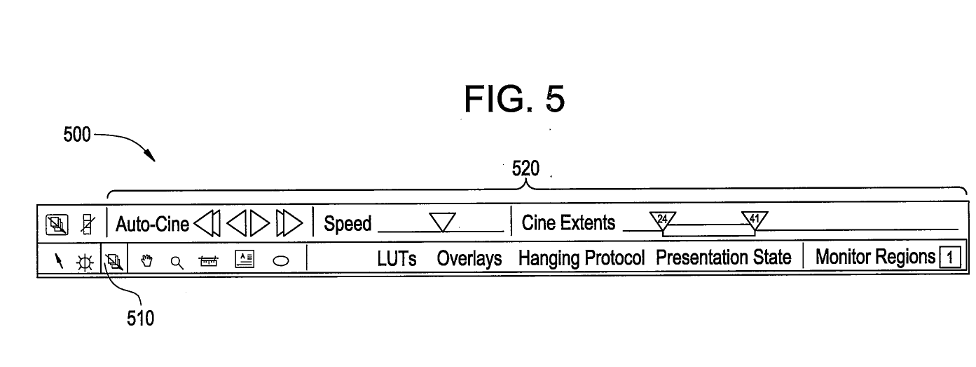

FIG. 5 depicts an exemplary tool bar 500 including inverted ribbon functionality in accordance with an embodiment of the present invention. In the example of FIG. 5, a cine tool 510 has been selected and various tool parameters 520 are displayed. For example, the cine tool 510 has associated parameters or options 520 such as an auto-cine mode, forward or backward advance between images, cine speed, cine extents, etc. Associated parameters 520 may be automatically

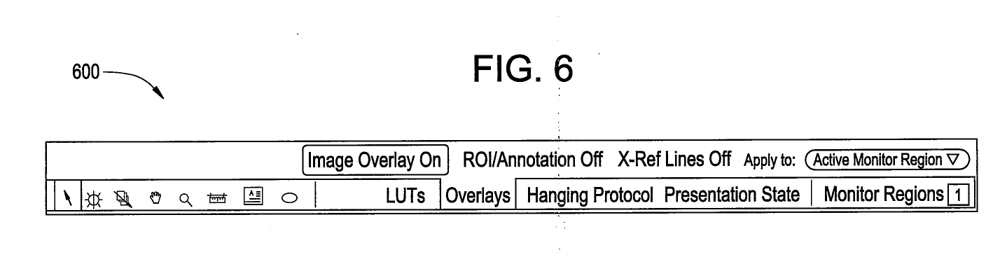

FIG. 6 shows another example of a tool bar 600 having inverted ribbon functionality in accordance with an embodiment of the present invention.

Thus, certain embodiments provide methods and systems for PACS software tool customization and interaction. Certain embodiments provide a pie tool menu that interacts with a submenu and/or tool ribbon menu and has several configuration options. A user selects a tool on the pie-shaped menu and associated and/or complementary tools with respect to the selected tool are automatically populated on the sub-tool bar. Ancillary and/or secondary tools related to a primary tool selected are displayed for easy selection by the user. A user interface provides user access to tool configurations. Among other reasons, a pie-shaped menu provides several advantages over traditional menus. For example, a traditional menu requires a separate focus away from an image being reviewed, whereas a pie menu enables a user to select from a limited number of tools without refocusing from the image under review.

In certain embodiments, as an example, eight segments or wedges are provided for selectable tools. In other embodiments, an alternate number of wedges, such as segments corresponding to compass points north, south, east, and west, may be used. In certain embodiments, a user may configure a number of pie menu segments available for tool selection.

In certain embodiments, pie wedges can adjust based on usage data and can reorganize. In certain embodiments, pie wedges remain static to help facilitate repetitive and intuitive pie wedge selection based on user muscle memory. For example, a user's brain associates a cine tool with an up and right movement to select the cine tool so that the user does not have to focus on the pie menu to select the tool and can instead keep his or her focus on an image being reviewed.

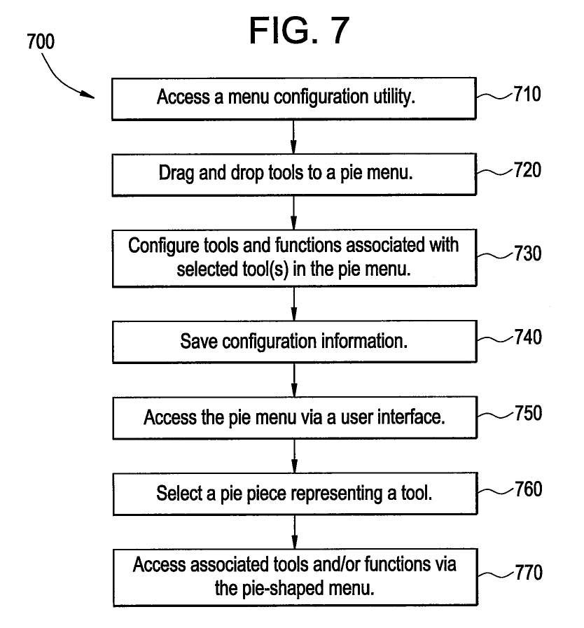

FIG. 7 shows a flow diagram for a method 700 for pie menu configuration and in accordance with an embodiment of the present invention. First, at step 710, a user accesses a menu configuration utility via a user interface. For example, a radiologist logins into a PACS workstation and accesses a reading user interface to configure menu and tool options for radiology reading.

At step 720, to configure, a user may drag and drop tools to a pie menu displayed on the interface. For example, a mouse and/or other pointing/moving device may be used to select a tool from a listing of available tools and position that selected tool in a desired segment of the pie menu. For example, a user may position tools in an eight-piece pie menu. As another example, a user may position tools in seven segments of an eight-piece pie menu with the eighth piece reserved for a “show all” tools option. The pie menu can be configured according to many different segment configurations, such as a four-segment configuration, six-segment configuration, etc.

At step 730, a user may configure tools and functions associated with one or more of the selected tools in the pie-shaped menu. For example, selection options and enhancements may be configured along with a selection tool place in the pie-shaped menu. Associated tools and/or functions may be placed in a tool bar or ribbon, for example, associated with the pie-shaped menu. As another example, associated tools and/or functions may be presented in a pop-up menu or list associated with the pie-shaped menu.

At step 740, configuration information for the pie-shaped menu and associated tools/functions may be saved. For example, a configuration may be saved for a particular user, group of users, location, etc. As another example, a configuration may be saved for a particular modality. Thus, different configurations may be created and saved for different modalities and/or different users, for example.

At step 750, a user accesses the pie menu configuration via a user interface. The user can load a configuration for a user, group, modality, etc.

At step 760, the user selects a pie piece representing a tool. For example, as a user is reading an image and/or associated data, the user may select a tool from the pie-shaped tool menu for use with respect to the image.

At step 770, the user accesses associated tools and/or functions via the pie-shaped menu. For example, if the user selects a cine tool from the pie-shaped menu and wishes to adjust characteristics of the cine with respect to CT images being reviewed, the user may select an associated cine speed option to control the rate of advance through the cine images.

One or more of the steps of the method 700 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

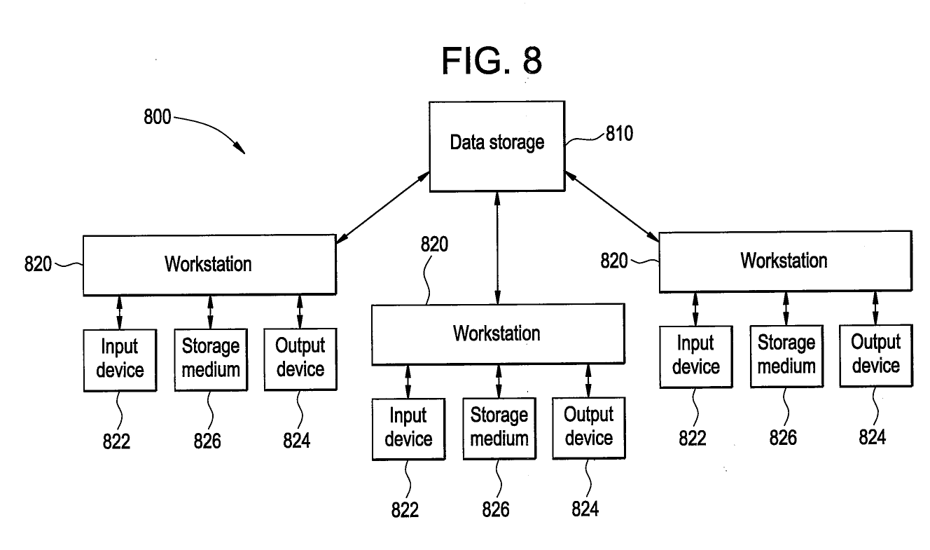

Certain embodiments of the user interface and menu described above may be implemented on a clinical information system, such as the system 800 of FIG. 8. In certain embodiments, an interface including patient information and images may be viewed and/or constructed using a system such as system 800 including at least one data storage 810 and at least one workstation 820. While three workstations 820 are illustrated in system 800, a larger or smaller number of workstations 820 can be used in accordance with embodiments of the presently described technology. In addition, while one data storage 810 is illustrated in system 800, system 800 can include more than one data storage 810. For example, each of a plurality of entities (such as remote data storage facilities, hospitals or clinics) can each include one or more data stores 810 in communication with one or more workstations 820.

As illustrated in system 800, one or more workstations 820 can be in communication with at least one other workstation 820 and/or at least one data storage 810. Workstations 820 can be located in a single physical location or in a plurality of locations. Workstations 820 can be connected to and communicate via one or more networks.

Workstations 820 can be directly attached to one or more data stores 810 and/or communicate with data storage 810 via one or more networks. Each workstation 820 can be implemented using a specialized or general-purpose computer executing a computer program for carrying out the processes described herein. Workstations 820 can be personal computers or host attached terminals, for example. If workstations 820 are personal computers, the processing described herein can be shared by one or more data stores 810 and a workstation 820 by providing an applet to workstation 820, for example.

Workstations 820 include an input device 822, an output device 824 and a storage medium 286. For example, workstations 820 can include a mouse, stylus, microphone and/or keyboard as an input device. Workstations 820 can include a computer monitor, liquid crystal display (“LCD”) screen, printer and/or speaker as an output device.

Storage medium 826 of workstations 820 is a computer-readable memory. For example, storage medium 826 can include a computer hard drive, a compact disc (“CD”) drive, a USB thumb drive, or any other type of memory capable of storing one or more computer software applications. Storage medium 826 can be included in workstations 820 or physically remote from workstations 820. For example, storage medium 826 can be accessible by workstations 820 through a wired or wireless network connection.

Storage medium 826 includes a set of instructions for a computer. The set of instructions includes one or more routines capable of being run or performed by workstations 820. The set of instructions can be embodied in one or more software applications or in computer code.

Data storage 810 can be implemented using a variety of devices for storing electronic information such as a file transfer protocol (“FTP”) server, for example. Data storage 810 includes electronic data. For example, data storage 810 can store patient exam images and/or other information, electronic medical records, patient orders, etc., for a plurality of patients. Data storage 810 may include and/or be in communication with one or more clinical information systems, for example.

Communication between workstations 820, workstations 820 and data storage 810, and/or a plurality of data stores 810 can be via any one or more types of known networks including a local area network (“LAN”), a wide area network (“WAN”), an intranet, or a global network (for example, Internet). Any two of workstations 820 and data stores 810 can be coupled to one another through multiple networks (for example, intranet and Internet) so that not all components of system 800 are required to be coupled to one another through the same network.

Any workstations 820 and/or data stores 810 can be connected to a network or one another in a wired or wireless fashion. In an example embodiment, workstations 820 and data store 810 communicate via the Internet and each workstation 820 executes a user interface application to directly connect to data store 810. In another embodiment, workstation 820 can execute a web browser to contact data store 810. Alternatively, workstation 820 can be implemented using a device programmed primarily for accessing data store 810.

Data storage 810 can be implemented using a server operating in response to a computer program stored in a storage medium accessible by the server. Data storage 810 can operate as a network server (often referred to as a web server) to communicate with workstations 820. Data storage 810 can handle sending and receiving information to and from workstations 820 and can perform associated tasks. Data storage 810 can also include a firewall to prevent unauthorized access and enforce any limitations on authorized access. For instance, an administrator can have access to the entire system and have authority to modify portions of system 800 and a staff member can only have access to view a subset of the data stored at data store 810. In an example embodiment, the administrator has the ability to add new users, delete users and edit user privileges. The firewall can be implemented using conventional hardware and/or software.

Data store 810 can also operate as an application server. Data store 810 can execute one or more application programs to provide access to the data repository located on data store 810. Processing can be shared by data store 810 and workstations 820 by providing an application (for example, a java applet). Alternatively, data store 810 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 810 can be implemented using a variety of devices for storing electronic information such as an FTP server. It is understood that the storage device can be implemented using memory contained in data store 810 or it may be a separate physical device. The storage device can include a variety of information including a data warehouse containing data such as patient medical data, for example.

Data storage 810 can also operate as a database server and coordinate access to application data including data stored on the storage device. Data storage 810 can be physically stored as a single database with access restricted based on user characteristics or it can be physically stored in a variety of databases.

In an embodiment, data storage 810 is configured to store data that is recorded with or associated with a time and/or date stamp. For example, a data entry can be stored in data storage 810 along with a time and/or date at which the data was entered or recorded initially or at data storage 810. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, data storage 810 is configured to store image and/or other medical data for a patient. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

Thus, certain embodiments provide a technical effect of a user-configurable menu allowing a user easy and intuitive access to tools for image review and analysis. Certain embodiments take advantage of user muscle memory and repetition to provide configurable tool options to a user. Certain embodiments reduce clutter and user confusion in an interface through use of a modality- and user-configurable tool menu.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

For example, certain embodiments provide a computer-readable storage medium including a set of instructions for execution on a computer. The set of instructions includes a user interface routine providing a pie menu of tools, each tool comprising a wedge in the pie menu selectable by a user to apply a tool to one or more images being reviewed. The set of instructions also includes a configuration routine adapted to allow a user to configure tools in the pie menu by dragging and dropping tools onto the wedges in the pie menu. The configuration routine allows a user to save a configuration according to at least one of a user and a modality. Configuration routine is adapted to allow a user to configure a tool bar of complementary tools and functions related to one or more wedges in the pie menu, the tool bar adapted for display via the user interface routine upon selection of one or more corresponding wedges in the pie menu. In certain embodiments, the tool bar is automatically populated with complementary tools and functions related to a tool wedge selected by a user from the pie-shaped menu.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A user interface providing software tools and customization for a picture archiving and communication system, said user interface comprising:
a pie-shaped menu including a plurality of tool segments arranged as pieces of said pie-shaped menu;
a pointer movable by a user to select one of said plurality of tool segments in said pie-shaped menu; and
an image review area displayed underneath said pie-shaped menu.

2. The user interface of claim 1, further comprising a tool bar including one or more tools and functions associated with a tool segment in said pie-shaped menu.

3. The user interface of claim 2, wherein said tool bar is automatically populated with complementary tools and functions related to a tool segment selected by a user from said pie-shaped menu.

4. The user interface of claim 1, wherein said pointer allows a user to select, drag, and release a tool segment from said pie-shaped menu to a portion of said image review area to apply said tool to said portion of said image review area.

5. The user interface of claim 1, wherein said plurality of tool segments in said pie-shaped menu are customized for a modality.

6. The user interface of claim 1, wherein said plurality of tool segments in said pie-shaped menu are customized for a user.

7. The user interface of claim 1, wherein said plurality of tool segments in said pie-shaped menu represent a set of most recently used tools in a particular context.

8. The user interface of claim 1, wherein one of said plurality of tool segments comprises a segment triggering a display of all available tools.

9. The user interface of claim 1, wherein said pie-shaped menu is configurable by a user to assign tools to each of said plurality of tool segments.

10. A picture archiving and communication system, said picture archiving and communication system comprising:
a circular menu including a plurality of wedge-shaped tool segments arranged within said circular menu;
a pointer movable by a user to select one of said plurality of tool segments in said pie-shaped menu;
an image review area displayed underneath said circular menu; and
a memory storing configuration information for said circular menu.

11. The system of claim 10, further comprising a tool bar including one or more tools and functions associated with a tool segment in said circular menu.

12. The system of claim 11, wherein said tool bar is automatically populated with complementary tools and functions related to a tool segment selected by a user from said pie-shaped menu.

13. The system of claim 11, wherein said plurality of tool segments in said circular menu are customized for a modality.

14. The system of claim 10, wherein one of said plurality of tool segments comprises a segment triggering a display of all available tools.

15. The system of claim 10, wherein said circular menu is configurable by a user to assign tools to each of said plurality of tool segments.

16. A computer-readable storage medium including a set of instructions for execution on a computer, the set of instructions comprising:
a user interface routine providing a pie menu of tools, each tool comprising a wedge in said pie menu selectable by a user to apply a tool to one or more images being reviewed; and
a configuration routine adapted to allow a user to configure tools in said pie menu by dragging and dropping tools onto said wedges in said pie menu, said configuration routine allowing a user to save a configuration according to at least one of a user and a modality,
wherein said configuration menu is adapted to allow a user to configure a tool bar of complementary tools and functions related to one or more wedges in said pie menu, said tool bar adapted for display via said user interface routine upon selection of one or more corresponding wedges in said pie menu.

17. The computer-readable storage medium of claim 16, wherein said tool bar is automatically populated with said complementary tools and functions related to a tool wedge selected by a user from said pie-shaped menu.

18. A method for tool menu configuration for image review, said method comprising:
providing available tools for a modality for configuration in a circular tool menu;
assigning available tools to segments in the circular tool menu based on user input; and
saving configuration information for a user to allow the circular tool menu to be accessed by the user for the modality.

19. The method of claim 18, wherein said assigning step further comprises dragging and dropping available tools to segments in the circular tool menu to assign tools to segments in the circular tool menu.

20. The method of claim 18, further comprising configuring complementary tools and functions associated with at least one tool segment configured in the circular tool menu, said complementary tools and functions configured in a tool bar displayed in conjunction with said circular tool menu.
